(19) United States
(12) Patent Application Publication
(10) Pub. No.: US 2017/0053190 A1
(43) Pub. Date: Feb. 23, 2017

(54) DETECTING AND CLASSIFYING PEOPLE OBSERVING A PERSON

(71) Applicant: Elwha LLC, Bellevue, WA (US)

(72) Inventors: Jesse R. Cheatham, III, Seattle, WA (US); Joel Cherkis, Redmond, WA (US); Paul H. Dietz, Redmond, WA (US); Tom Driscoll, San Diego, CA (US); William David Duncan, Mill Creek, WA (US); William Gates, Medina, WA (US); Roderick A. Hyde, Redmond, WA (US); Muriel Y. Ishikawa, Livermore, CA (US); Neil Jordan, Redmond, WA (US); Jordin T. Kare, San Jose, CA (US); Eric C. Leuthardt, St. Louis, MO (US); Nathan P. Myhrvold, Medina, WA (US); Patrick Neill, Sammamish, WA (US); Tony S. Pan, Bellevue, WA (US); Robert C. Petroski, Seattle, WA (US); David R. Smith, Durham, NC (US); Elizabeth A. Sweeney, Seattle, WA (US); Desney S. Tan, Kirkland, WA (US); Clarence T. Tegreene, Mercer Island, WA (US); David Lawrence Tennenhouse, Hillsborough, CA (US); Yaroslav A. Urzhumov, Bellevue, WA (US); Gary Wachowicz, Lake Tapps, WA (US); Lowell L. Wood, Bellevue, WA (US); Victoria Y.H. Wood, Livermore, CA (US)

(21) Appl. No.: 14/830,950

(22) Filed: Aug. 20, 2015

(51) Int. Cl. G06K 9/62; G06K 9/00

(52) U.S. Cl. CPC G06K 9/6267; G06K 9/00288

(57) ABSTRACT

Described embodiments include a system, article of manufacture, a system implemented in a machine, article of manufacture, or composition of matter, and computer-implemented method. A computer-implemented method includes electronically receiving a digital image of person observing a subject person. The method includes determining from the digital image an interest-level in the subject person by the imaged person. The method includes electronically outputting the determined interest-level. In an embodiment, the method includes storing at least one digital image of the monitored person in a non-transitory computer readable storage media.

If an Application Data Sheet (ADS) has been filed on the filing date of this application, it is incorporated by reference herein. Any applications claimed on the ADS for priority under 35 U.S.C. §§119, 120, 121, or 365(c), and any and all parent, grandparent, great-grandparent, etc. applications of such applications, are also incorporated by reference, including any priority claims made in those applications and any material incorporated by reference, to the extent such subject matter is not inconsistent herewith.

### CROSS-REFERENCE TO RELATED APPLICATIONS

The present application claims the benefit of the earliest available effective filing date(s) from the following listed application(s) (the “Priority Applications”), if any, listed below (e.g., claims earliest available priority dates for other than provisional patent applications or claims benefits under 35 USC §119(e) for provisional patent applications, for any and all parent, grandparent, great-grandparent, etc. applications of the Priority Application(s)).

### PRIORITY APPLICATIONS

None.

If the listings of applications provided above are inconsistent with the listings provided via an ADS, it is the intent of the Applicant to claim priority to each application that appears in the Domestic Benefit/National Stage Information section of the ADS and to each application that appears in the Priority Applications section of this application.

All subject matter of the Priority Applications and of any and all applications related to the Priority Applications by priority claims (directly or indirectly), including any priority claims made and subject matter incorporated by reference therein as of the filing date of the instant application, is incorporated herein by reference to the extent such subject matter is not inconsistent herewith.

### SUMMARY

For example, and without limitation, an embodiment of the subject matter described herein includes a system. The system includes circuitry for receiving a digital image of person observing a subject person. The system includes circuitry for determining from the digital image an interest-level in the subject person by the imaged person. The system includes circuitry for outputting the determined interest-level.

In an embodiment of the system, the circuitry for determining includes circuitry for determining from the digital image an interest-level in the subject person by the imaged person on a scale that includes a high interest-level and a low interest-level. In an embodiment, the system includes circuitry for designating the imaged person evidencing a high interest-level as a person to be monitored. In this embodiment, the system includes circuitry for electronically receiving a subsequently captured digital image of the monitored person. In this embodiment, the system includes circuitry for determining from the digital image an interest-level in the subject person by the monitored person. In this embodiment, the system includes circuitry for electronically outputting the determined interest-level of the monitored person. In an embodiment, the system includes circuitry for storing at least one digital image of the monitored person in a non-transitory computer readable storage media. In an embodiment, the system includes circuitry for searching previously acquired digital images of persons observing the subject person for a digital image of the monitored person observing the subject person. In an embodiment, the system includes circuitry for identifying the imaged person. In an embodiment, the system includes circuitry for receiving the electronically outputted determined interest-level; and circuitry for broadcasting a notification perceivable by the subject person and responsive to the determined interest-level.

For example, and without limitation, an embodiment of the subject matter described herein includes an article of manufacture. The article of manufacture includes a non-transitory storage medium bearing one or more instructions for electronically receiving a digital image of person observing a subject person. The medium includes one or more instructions for determining from the digital image an interest-level in the subject person by the imaged person. The medium includes one or more instructions for electronically outputting the determined interest-level.

For example, and without limitation, an embodiment of the subject matter described herein includes a system implemented in a machine, article of manufacture, or composition of matter. The system includes a receiver module configured to electronically receive a digital image of person observing a subject person. The system includes an evaluation module configured to determine from the digital image an interest-level in the subject person by the imaged person. The system includes an output module configured to electronically output the determined interest-level.

For example, and without limitation, an embodiment of the subject matter described herein includes a computer-implemented method. The method includes electronically receiving a digital image of person observing a subject person. The method includes determining from the digital image an interest-level in the subject person by the imaged person. The method includes electronically outputting the determined interest-level.

In an embodiment, the method includes identifying the imaged person. In an embodiment, the method includes designating an imaged person evidencing the high interest-level as a person to be monitored. In this embodiment, the method includes electronically receiving a subsequently captured digital image of the monitored person. In this embodiment, the method includes determining from the digital image an interest-level in the subject person by the monitored person. In this embodiment, the method includes electronically outputting the determined interest-level of the monitored person. In an embodiment, the method includes storing at least one digital image of the monitored person in a non-transitory computer readable storage media. In an embodiment, the method includes searching previously acquired digital images of persons observing the subject person for a digital image of the monitored person observing the subject person.

In an embodiment, the method includes receiving in a mobile electronic device the electronically outputted determined interest-level; and broadcasting by the mobile electronic device a notification of the determined interest-level. In an embodiment, the method includes receiving in an electronic device the electronically outputted determined interest-level; and broadcasting a notification perceivable by the imaged person and responsive to the determined interest-level.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE DRAWINGS

FIG. 1 illustrates an example embodiment of an environment 19 that includes a thin computing device 20 in which embodiments may be implemented;

FIG. 2 illustrates an example embodiment of an environment 100 that includes a general-purpose computing system 110 in which embodiments may be implemented;

FIG. 3 schematically illustrates an example environment 200 in which embodiments of a system 240 may be implemented;

FIG. 4 illustrates an example article of manufacture 300;

FIG. 5 illustrates an example environment 400 that includes system 440 implemented in a machine, article of manufacture, or composition of matter; and

FIG. 6 illustrates an example operational flow of a computer-implemented method 500.

### DETAILED DESCRIPTION

In the following detailed description, reference is made to the accompanying drawings, which form a part hereof. In the drawings, similar symbols typically identify similar components, unless context dictates otherwise. The illustrated embodiments described in the detailed description, drawings, and claims are not meant to be limiting. Other embodiments may be utilized, and other changes may be made, without departing from the spirit or scope of the subject matter presented here.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware in one or more machines, compositions of matter, and articles of manufacture, limited to patentable subject matter under 35 USC 101. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

In some implementations described herein, logic and similar implementations may include computer programs or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software (e.g., a high-level computer program serving as a hardware specification) or firmware, or of gate arrays or programmable hardware, such as by performing a reception of or a transmission of one or more instructions in relation to one or more operations described herein. Alternatively or additionally, in some variants, an implementation may include special-purpose hardware, software (e.g., a high-level computer program serving as a hardware specification), firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Alternatively or additionally, implementations may include executing a special-purpose instruction sequence or invoking circuitry for enabling, triggering, coordinating, requesting, or otherwise causing one or more occurrences of virtually any functional operation described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled/implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog®-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

The claims, description, and drawings of this application may describe one or more of the instant technologies in operational/functional language, for example as a set of operations to be performed by a computer. Such operational/functional description in most instances would be understood by one skilled in the art as specifically-configured hardware (e.g., because a general purpose computer in effect becomes a special purpose computer once it is programmed to perform particular functions pursuant to instructions from program software (e.g., a high-level computer program serving as a hardware specification)).

Importantly, although the operational/functional descriptions described herein are understandable by the human mind, they are not abstract ideas of the operations/functions divorced from computational implementation of those operations/functions. Rather, the operations/functions represent a specification for massively complex computational machines or other means. As discussed in detail below, the operational/functional language must be read in its proper technological context, i.e., as concrete specifications for physical implementations.

The logical operations/functions described herein are a distillation of machine specifications or other physical mechanisms specified by the operations/functions such that the otherwise inscrutable machine specifications may be comprehensible to a human reader. The distillation also allows one of skill in the art to adapt the operational/functional description of the technology across many different specific vendors' hardware configurations or platforms, without being limited to specific vendors' hardware configurations or platforms.

Some of the present technical description (e.g., detailed description, drawings, claims, etc.) may be set forth in terms of logical operations/functions. As described in more detail herein, these logical operations/functions are not representations of abstract ideas, but rather are representative of static or sequenced specifications of various hardware elements. Differently stated, unless context dictates otherwise, the logical operations/functions will be understood by those of skill in the art to be representative of static or sequenced specifications of various hardware elements. This is true because tools available to one of skill in the art to implement technical disclosures set forth in operational/functional formats—tools in the form of a high-level programming language (e.g., C, java, visual basic), etc.), or tools in the form of Very high speed Hardware Description Language (“VHDL,” which is a language that uses text to describe logic circuits)—are generators of static or sequenced specifications of various hardware configurations. This fact is sometimes obscured by the broad term “software,” but, as shown by the following explanation, those skilled in the art understand that what is termed “software” is a shorthand for a massively complex interchaining/specification of ordered-matter elements. The term “ordered-matter elements” may refer to physical components of computation, such as assemblies of electronic logic gates, molecular computing logic constituents, quantum computing mechanisms, etc.

For example, a high-level programming language is a programming language with strong abstraction, e.g., multiple levels of abstraction, from the details of the sequential organizations, states, inputs, outputs, etc., of the machines that a high-level programming language actually specifies. In order to facilitate human comprehension, in many instances, high-level programming languages resemble or even share symbols with natural languages.

It has been argued that because high-level programming languages use strong abstraction (e.g., that they may resemble or share symbols with natural languages), they are therefore a “purely mental construct” (e.g., that “software”—a computer program or computer programming—is somehow an ineffable mental construct, because at a high level of abstraction, it can be conceived and understood by a human reader). This argument has been used to characterize technical description in the form of functions/operations as somehow “abstract ideas.” In fact, in technological arts (e.g., the information and communication technologies) this is not true.

The fact that high-level programming languages use strong abstraction to facilitate human understanding should not be taken as an indication that what is expressed is an abstract idea. In fact, those skilled in the art understand that just the opposite is true. If a high-level programming language is the tool used to implement a technical disclosure in the form of functions/operations, those skilled in the art will recognize that, far from being abstract, imprecise, “fuzzy,” or “mental” in any significant semantic sense, such a tool is instead a near incomprehensibly precise sequential specification of specific computational machines—the parts of which are built up by activating/selecting such parts from typically more general computational machines over time (e.g., clocked time). This fact is sometimes obscured by the superficial similarities between high-level programming languages and natural languages. These superficial similarities also may cause a glossing over of the fact that high-level programming language implementations ultimately perform valuable work by creating/controlling many different computational machines.

The many different computational machines that a high-level programming language specifies are almost unimaginably complex. At base, the hardware used in the computational machines typically consists of some type of ordered matter (e.g., traditional electronic devices (e.g., transistors), deoxyribonucleic acid (DNA), quantum devices, mechanical switches, optics, fluidics, pneumatics, optical devices (e.g., optical interference devices), molecules, etc.) that are arranged to form logic gates. Logic gates are typically physical devices that may be electrically, mechanically, chemically, or otherwise driven to change physical state in order to create a physical reality of logic, such as Boolean logic.

Logic gates may be arranged to form logic circuits, which are typically physical devices that may be electrically, mechanically, chemically, or otherwise driven to create a physical reality of certain logical functions. Types of logic circuits include such devices as multiplexers, registers, arithmetic logic units (ALUs), computer memory, etc., each type of which may be combined to form yet other types of physical devices, such as a central processing unit (CPU)—the best known of which is the microprocessor. A modern microprocessor will often contain more than one hundred million logic gates in its many logic circuits (and often more than a billion transistors).

The logic circuits forming the microprocessor are arranged to provide a microarchitecture that will carry out the instructions defined by that microprocessor's defined Instruction Set Architecture. The Instruction Set Architecture is the part of the microprocessor architecture related to programming, including the native data types, instructions, registers, addressing modes, memory architecture, interrupt and exception handling, and external Input/Output.

The Instruction Set Architecture includes a specification of the machine language that can be used by programmers to use/control the microprocessor. Since the machine language instructions are such that they may be executed directly by the microprocessor, typically they consist of strings of binary digits, or bits. For example, a typical machine language instruction might be many bits long (e.g., 32, 64, or 128 bit strings are currently common). A typical machine language instruction might take the form “11110000101011110000111100111111” (a 32 bit instruction).

It is significant here that, although the machine language instructions are written as sequences of binary digits, in actuality those binary digits specify physical reality. For example, if certain semiconductors are used to make the operations of Boolean logic a physical reality, the apparently mathematical bits “1” and “0” in a machine language instruction actually constitute a shorthand that specifies the application of specific voltages to specific wires. For example, in some semiconductor technologies, the binary number “1” (e.g., logical “1”) in a machine language instruction specifies around +5 volts applied to a specific “wire” (e.g., metallic traces on a printed circuit board) and the binary number “0” (e.g., logical “0”) in a machine language instruction specifies around −5 volts applied to a specific “wire.” In addition to specifying voltages of the machines' configurations, such machine language instructions also select out and activate specific groupings of logic gates from the millions of logic gates of the more general machine. Thus, far from abstract mathematical expressions, machine language instruction programs, even though written as a string of zeros and ones, specify many, many constructed physical machines or physical machine states.

Machine language is typically incomprehensible by most humans (e.g., the above example was just ONE instruction, and some personal computers execute more than two billion instructions every second). Thus, programs written in machine language—which may be tens of millions of machine language instructions long—are incomprehensible to most humans. In view of this, early assembly languages were developed that used mnemonic codes to refer to machine language instructions, rather than using the machine language instructions' numeric values directly (e.g., for performing a multiplication operation, programmers coded the abbreviation “mult,” which represents the binary number “011000” in MIPS machine code). While assembly languages were initially a great aid to humans controlling the microprocessors to perform work, in time the complexity of the work that needed to be done by the humans outstripped the ability of humans to control the microprocessors using merely assembly languages.

At this point, it was noted that the same tasks needed to be done over and over, and the machine language necessary to do those repetitive tasks was the same. In view of this, compilers were created. A compiler is a device that takes a statement that is more comprehensible to a human than either machine or assembly language, such as “add 2+2 and output the result,” and translates that human understandable statement into a complicated, tedious, and immense machine language code (e.g., millions of 32, 64, or 128 bit length strings). Compilers thus translate high-level programming language into machine language.

This compiled machine language, as described above, is then used as the technical specification which sequentially constructs and causes the interoperation of many different computational machines such that useful, tangible, and concrete work is done. For example, as indicated above, such machine language—the compiled version of the higher-level language—functions as a technical specification which selects out hardware logic gates, specifies voltage levels, voltage transition timings, etc., such that the useful work is accomplished by the hardware.

Thus, a functional/operational technical description, when viewed by one of skill in the art, is far from an abstract idea. Rather, such a functional/operational technical description, when understood through the tools available in the art such as those just described, is instead understood to be a humanly understandable representation of a hardware specification, the complexity and specificity of which far exceeds the comprehension of most any one human. With this in mind, those skilled in the art will understand that any such operational/functional technical descriptions—in view of the disclosures herein and the knowledge of those skilled in the art—may be understood as operations made into physical reality by (a) one or more interchained physical machines, (b) interchained logic gates configured to create one or more physical machine(s) representative of sequential/combinatorial logic(s), (c) interchained ordered matter making up logic gates (e.g., interchained electronic devices (e.g., transistors), DNA, quantum devices, mechanical switches, optics, fluidics, pneumatics, molecules, etc.) that create physical reality of logic(s), or (d) virtually any combination of the foregoing. Indeed, any physical object which has a stable, measurable, and changeable state may be used to construct a machine based on the above technical description. Charles Babbage, for example, constructed the first mechanized computational apparatus out of wood, with the apparatus powered by cranking a handle.

Thus, far from being understood as an abstract idea, those skilled in the art will recognize a functional/operational technical description as a humanly-understandable representation of one or more almost unimaginably complex and time sequenced hardware instantiations. The fact that functional/operational technical descriptions might lend themselves readily to high-level computing languages (or high-level block diagrams for that matter) that share some words, structures, phrases, etc. with natural language should not be taken as an indication that such functional/operational technical descriptions are abstract ideas, or mere expressions of abstract ideas. In fact, as outlined herein, in the technological arts this is simply not true. When viewed through the tools available to those of skill in the art, such functional/operational technical descriptions are seen as specifying hardware configurations of almost unimaginable complexity.

As outlined above, the reason for the use of functional/operational technical descriptions is at least twofold. First, the use of functional/operational technical descriptions allows near-infinitely complex machines and machine operations arising from interchained hardware elements to be described in a manner that the human mind can process (e.g., by mimicking natural language and logical narrative flow). Second, the use of functional/operational technical descriptions assists the person of skill in the art in understanding the described subject matter by providing a description that is more or less independent of any specific vendor's piece(s) of hardware.

The use of functional/operational technical descriptions assists the person of skill in the art in understanding the described subject matter since, as is evident from the above discussion, one could easily, although not quickly, transcribe the technical descriptions set forth in this document as trillions of ones and zeroes, billions of single lines of assembly-level machine code, millions of logic gates, thousands of gate arrays, or any number of intermediate levels of abstractions. However, if any such low-level technical descriptions were to replace the present technical description, a person of skill in the art could encounter undue difficulty in implementing the disclosure, because such a low-level technical description would likely add complexity without a corresponding benefit (e.g., by describing the subject matter utilizing the conventions of one or more vendor-specific pieces of hardware). Thus, the use of functional/operational technical descriptions assists those of skill in the art by separating the technical descriptions from the conventions of any vendor-specific piece of hardware.

In view of the foregoing, the logical operations/functions set forth in the present technical description are representative of static or sequenced specifications of various ordered-matter elements, in order that such specifications may be comprehensible to the human mind and adaptable to create many various hardware configurations. The logical operations/functions disclosed herein should be treated as such, and should not be disparagingly characterized as abstract ideas merely because the specifications they represent are presented in a manner that one of skill in the art can readily understand and apply in a manner independent of a specific vendor's hardware implementation.

The term module, as used in the foregoing/following disclosure, may refer to a collection of one or more components that are arranged in a particular manner, or a collection of one or more general-purpose components that may be configured to operate in a particular manner at one or more particular points in time, and/or also configured to operate in one or more further manners at one or more further times. For example, the same hardware, or same portions of hardware, may be configured/reconfigured in sequential/parallel time(s) as a first type of module (e.g., at a first time), as a second type of module (e.g., at a second time, which may in some instances coincide with, overlap, or follow a first time), and/or as a third type of module (e.g., at a third time which may, in some instances, coincide with, overlap, or follow a first time and/or a second time), etc. Reconfigurable and/or controllable components (e.g., general purpose processors, digital signal processors, field programmable gate arrays, etc.) are capable of being configured as a first module that has a first purpose, then a second module that has a second purpose and then, a third module that has a third purpose, and so on. The transition of a reconfigurable and/or controllable component may occur in as little as a few nanoseconds, or may occur over a period of minutes, hours, or days.

In some such examples, at the time the component is configured to carry out the second purpose, the component may no longer be capable of carrying out that first purpose until it is reconfigured. A component may switch between configurations as different modules in as little as a few nanoseconds. A component may reconfigure on-the-fly, e.g., the reconfiguration of a component from a first module into a second module may occur just as the second module is needed. A component may reconfigure in stages, e.g., portions of a first module that are no longer needed may reconfigure into the second module even before the first module has finished its operation. Such reconfigurations may occur automatically, or may occur through prompting by an external source, whether that source is another component, an instruction, a signal, a condition, an external stimulus, or similar.

For example, a central processing unit of a personal computer may, at various times, operate as a module for displaying graphics on a screen, a module for writing data to a storage medium, a module for receiving user input, and a module for multiplying two large prime numbers, by configuring its logical gates in accordance with its instructions. Such reconfiguration may be invisible to the naked eye, and in some embodiments may include activation, deactivation, and/or re-routing of various portions of the component, e.g., switches, logic gates, inputs, and/or outputs. Thus, in the examples found in the foregoing/following disclosure, if an example includes or recites multiple modules, the example includes the possibility that the same hardware may implement more than one of the recited modules, either contemporaneously or at discrete times or timings. The implementation of multiple modules, whether using more components, fewer components, or the same number of components as the number of modules, is merely an implementation choice and does not generally affect the operation of the modules themselves. Accordingly, it should be understood that any recitation of multiple discrete modules in this disclosure includes implementations of those modules as any number of underlying components, including, but not limited to, a single component that reconfigures itself over time to carry out the functions of multiple modules, and/or multiple components that similarly reconfigure, and/or special purpose reconfigurable components.

In a general sense, those skilled in the art will recognize that the various embodiments described herein can be implemented, individually and/or collectively, by various types of electro-mechanical systems having a wide range of electrical components such as hardware, software (e.g., a high-level computer program serving as a hardware specification), firmware, and/or virtually any combination thereof, limited to patentable subject matter under 35 U.S.C. 101; and a wide range of components that may impart mechanical force or motion such as rigid bodies, spring or torsional bodies, hydraulics, electro-magnetically actuated devices, and/or virtually any combination thereof. Consequently, as used herein “electro-mechanical system” includes, but is not limited to, electrical circuitry operably coupled with a transducer (e.g., an actuator, a motor, a piezoelectric crystal, a Micro Electro Mechanical System (MEMS), etc.), electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), electrical circuitry forming a communications device (e.g., a modem, communications switch, optical-electrical equipment, etc.), and/or any non-electrical analog thereto, such as optical or other analogs (e.g., graphene based circuitry). Those skilled in the art will also appreciate that examples of electro-mechanical systems include but are not limited to a variety of consumer electronics systems, medical devices, as well as other systems such as motorized transport systems, factory automation systems, security systems, and/or communication/computing systems. Those skilled in the art will recognize that electro-mechanical as used herein is not necessarily limited to a system that has both electrical and mechanical actuation except as context may dictate otherwise.

In a general sense, those skilled in the art will recognize that the various aspects described herein which can be implemented, individually and/or collectively, by a wide range of hardware, software (e.g., a high-level computer program serving as a hardware specification), firmware, and/or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

Those skilled in the art will recognize that at least a portion of the devices and/or processes described herein can be integrated into an image processing system. Those having skill in the art will recognize that a typical image processing system generally includes one or more of a system unit housing, a video display device, memory such as volatile or non-volatile memory, processors such as microprocessors or digital signal processors, computational entities such as operating systems, drivers, applications programs, one or more interaction devices (e.g., a touch pad, a touch screen, an antenna, etc.), control systems including feedback loops and control motors (e.g., feedback for sensing lens position and/or velocity; control motors for moving/distorting lenses to give desired focuses). An image processing system may be implemented utilizing suitable commercially available components, such as those typically found in digital still systems and/or digital motion systems.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems.

Those skilled in the art will recognize that at least a portion of the devices and/or processes described herein can be integrated into a mote system. Those having skill in the art will recognize that a typical mote system generally includes one or more memories such as volatile or non-volatile memories, processors such as microprocessors or digital signal processors, computational entities such as operating systems, user interfaces, drivers, sensors, actuators, applications programs, one or more interaction devices (e.g., an antenna USB ports, acoustic ports, etc.), control systems including feedback loops and control motors (e.g., feedback for sensing or estimating position and/or velocity; control motors for moving and/or adjusting components and/or quantities). A mote system may be implemented utilizing suitable components, such as those found in mote computing/communication systems. Specific examples of such components entail such as Intel Corporation's and/or Crossbow Corporation's mote components and supporting hardware, software (e.g., a high-level computer program serving as a hardware specification), and/or firmware.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, Verizon, AT&T, etc.), or (g) a wired/wireless services entity (e.g., Sprint, AT&T, Verizon, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory).

A sale of a system or method may likewise occur in a territory even if components of the system or method are located and/or used outside the territory. Further, implementation of at least part of a system for performing a method in one territory does not preclude use of the system in another territory.

One skilled in the art will recognize that the herein described components (e.g., operations), devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components (e.g., operations), devices, and objects should not be taken limiting.

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

The herein described subject matter sometimes illustrates different components contained within, or connected with, different other components. It is to be understood that such depicted architectures are merely exemplary, and that in fact many other architectures may be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected”, or “operably coupled,” to each other to achieve the desired functionality, and any two components capable of being so associated can also be viewed as being “operably couplable,” to each other to achieve the desired functionality. Specific examples of operably couplable include but are not limited to physically mateable and/or physically interacting components, and/or wirelessly interactable, and/or wirelessly interacting components, and/or logically interacting, and/or logically interactable components.

In some instances, one or more components may be referred to herein as “configured to,” “configured by,” “configurable to,” “operable/operative to,” “adapted/adaptable,” “able to,” “conformable/conformed to,” etc. Those skilled in the art will recognize that such terms (e.g. “configured to”) generally encompass active-state components and/or inactive-state components and/or standby-state components, unless context requires otherwise.

For the purposes of this application, “cloud” computing may be understood as described in the cloud computing literature. For example, cloud computing may be methods and/or systems for the delivery of computational capacity and/or storage capacity as a service. The “cloud” may refer to one or more hardware and/or software (e.g., a high-level computer program serving as a hardware specification) components that deliver or assist in the delivery of computational and/or storage capacity, including, but not limited to, one or more of a client, an application, a platform, an infrastructure, and/or a server. The cloud may refer to any of the hardware and/or software (e.g., a high-level computer program serving as a hardware specification) associated with a client, an application, a platform, an infrastructure, and/or a server. For example, cloud and cloud computing may refer to one or more of a computer, a processor, a storage medium, a router, a switch, a modem, a virtual machine (e.g., a virtual server), a data center, an operating system, a middleware, a firmware, a hardware back-end, an application back-end, and/or a programmed application. A cloud may refer to a private cloud, a public cloud, a hybrid cloud, and/or a community cloud. A cloud may be a shared pool of configurable computing resources, which may be public, private, semi-private, distributable, scaleable, flexible, temporary, virtual, and/or physical. A cloud or cloud service may be delivered over one or more types of network, e.g., a mobile communication network, and the Internet.

As used in this application, a cloud or a cloud service may include one or more of infrastructure-as-a-service (“IaaS”), platform-as-a-service (“PaaS”), software-as-a-service (“SaaS”), and/or desktop-as-a-service (“DaaS”). As a non-exclusive example, IaaS may include, e.g., one or more virtual server instantiations that may start, stop, access, and/or configure virtual servers and/or storage centers (e.g., providing one or more processors, storage space, and/or network resources on-demand, e.g., EMC and Rackspace). PaaS may include, e.g., one or more program, module, and/or development tools hosted on an infrastructure (e.g., a computing platform and/or a solution stack from which the client can create software-based interfaces and applications, e.g., Microsoft Azure). SaaS may include, e.g., software hosted by a service provider and accessible over a network (e.g., the software for the application and/or the data associated with that software application may be kept on the network, e.g., Google Apps, SalesForce). DaaS may include, e.g., providing desktop, applications, data, and/or services for the user over a network (e.g., providing a multi-application framework, the applications in the framework, the data associated with the applications, and/or services related to the applications and/or the data over the network, e.g., Citrix). The foregoing is intended to be exemplary of the types of systems and/or methods referred to in this application as “cloud” or “cloud computing” and should not be considered complete or exhaustive.

This application may make reference to one or more trademarks, e.g., a word, letter, symbol, or device adopted by one manufacturer or merchant and used to identify and/or distinguish his or her product from those of others. Trademark names used herein are set forth in such language that makes clear their identity, that distinguishes them from common descriptive nouns, that have fixed and definite meanings, or, in many if not all cases, are accompanied by other specific identification using terms not covered by trademark. In addition, trademark names used herein have meanings that are well-known and defined in the literature, or do not refer to products or compounds for which knowledge of one or more trade secrets is required in order to divine their meaning. All trademarks referenced in this application are the property of their respective owners, and the appearance of one or more trademarks in this application does not diminish or otherwise adversely affect the validity of the one or more trademarks. All trademarks, registered or unregistered, that appear in this application are assumed to include a proper trademark symbol, e.g., the circle R or bracketed capitalization (e.g., [trademark name]), even when such trademark symbol does not explicitly appear next to the trademark. To the extent a trademark is used in a descriptive manner to refer to a product or process, that trademark should be interpreted to represent the corresponding product or process as of the date of the filing of this patent application.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

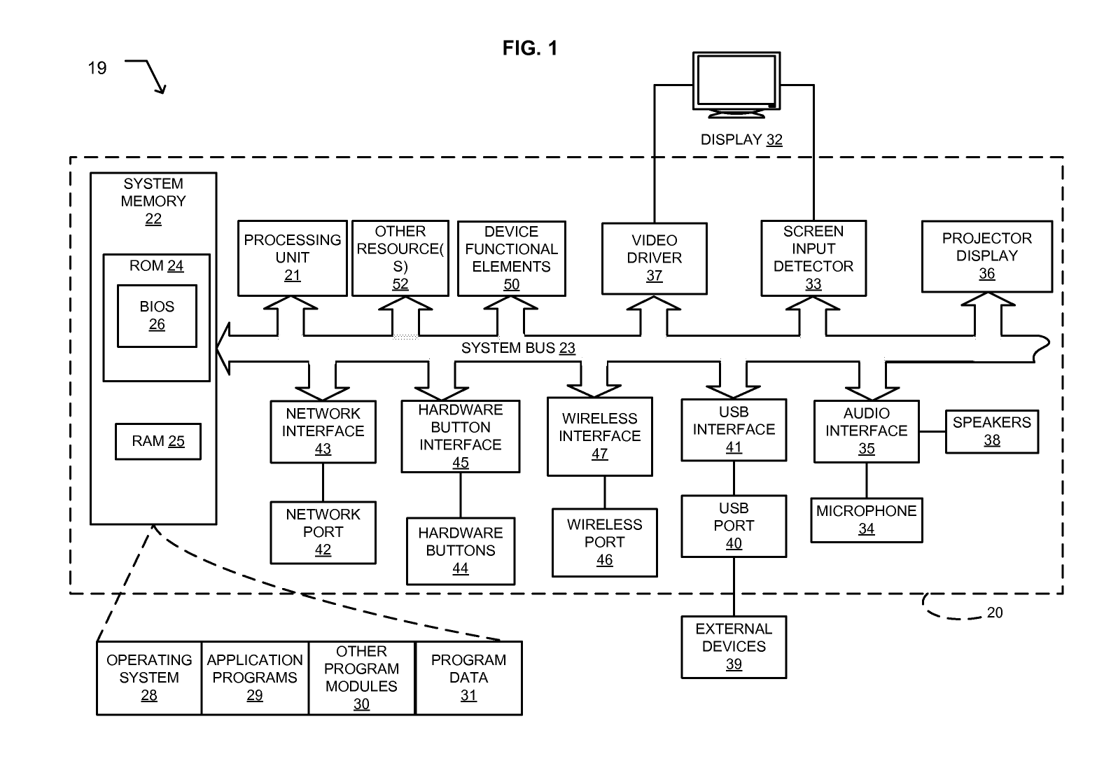

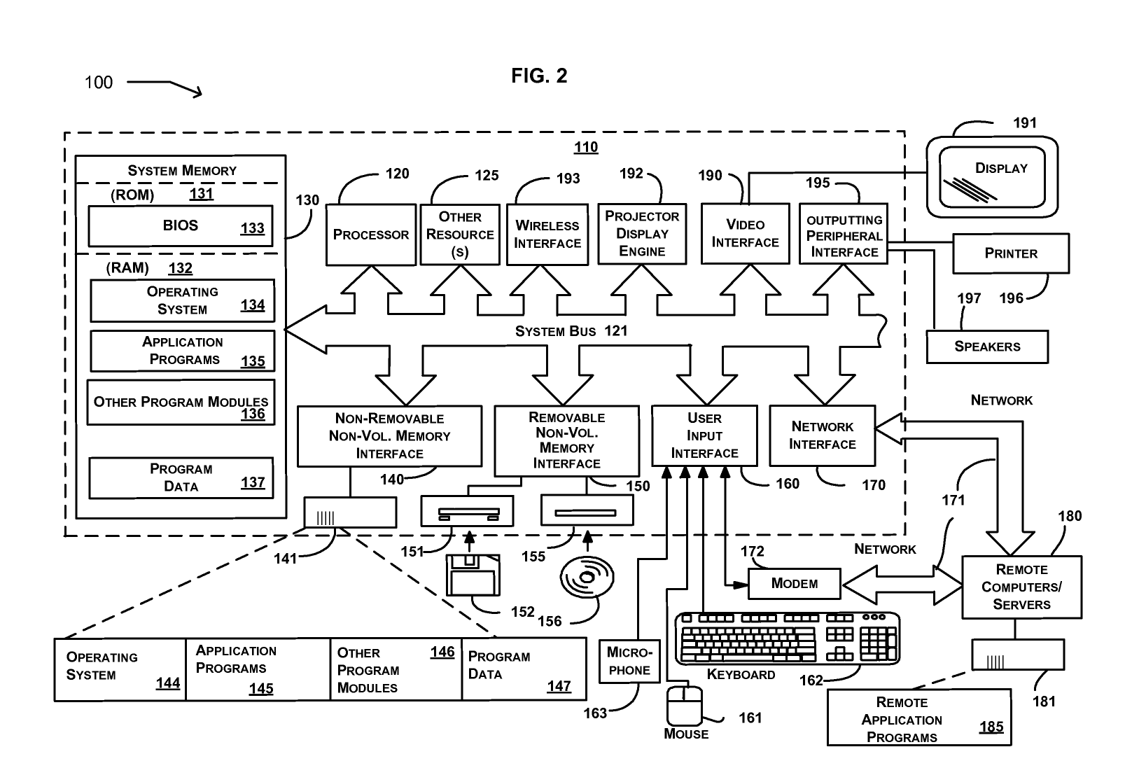

FIGS. 1 and 2 provide respective general descriptions of several environments in which implementations may be implemented. FIG. 1 is generally directed toward a thin computing environment 19 having a thin computing device 20, and FIG. 2 is generally directed toward a general purpose computing environment 100 having general purpose computing device 110. However, as prices of computer components drop and as capacity and speeds increase, there is not always a bright line between a thin computing device and a general purpose computing device. Further, there is a continuous stream of new ideas and applications for environments benefited by use of computing power. As a result, nothing should be construed to limit disclosed subject matter herein to a specific computing environment unless limited by express language.

FIG. 1 and the following discussion are intended to provide a brief, general description of a thin computing environment 19 in which embodiments may be implemented. FIG. 1 illustrates an example system that includes a thin computing device 20, which may be included or embedded in an electronic device that also includes a device functional element 50. For example, the electronic device may include any item having electrical or electronic components playing a role in a functionality of the item, such as for example, a refrigerator, a car, a digital image acquisition device, a camera, a cable modem, a printer, an ultrasound device, an x-ray machine, a non-invasive imaging device, or an airplane. For example, the electronic device may include any item that interfaces with or controls a functional element of the item. In another example, the thin computing device may be included in an implantable medical apparatus or device. In a further example, the thin computing device may be operable to communicate with an implantable or implanted medical apparatus. For example, a thin computing device may include a computing device having limited resources or limited processing capability, such as a limited resource computing device, a wireless communication device, a mobile wireless communication device, a smart phone, an electronic pen, a handheld electronic writing device, a scanner, a cell phone, a smart phone (such as an Android® or iPhone® based device), a tablet device (such as an iPad®) or a Blackberry® device. For example, a thin computing device may include a thin client device or a mobile thin client device, such as a smart phone, tablet, notebook, or desktop hardware configured to function in a virtualized environment.

The thin computing device 20 includes a processing unit 21, a system memory 22, and a system bus 23 that couples various system components including the system memory 22 to the processing unit 21. The system bus 23 may be any of several types of bus structures including a memory bus or memory controller, a peripheral bus, and a local bus using any of a variety of bus architectures. The system memory includes read-only memory (ROM) 24 and random access memory (RAM) 25. A basic input/output system (BIOS) 26, containing the basic routines that help to transfer information between sub-components within the thin computing device 20, such as during start-up, is stored in the ROM 24. A number of program modules may be stored in the ROM 24 or RAM 25, including an operating system 28, one or more application programs 29, other program modules 30 and program data 31.

A user may enter commands and information into the computing device 20 through one or more input interfaces. An input interface may include a touch-sensitive screen or display surface, or one or more switches or buttons with suitable input detection circuitry. A touch-sensitive screen or display surface is illustrated as a touch-sensitive display 32 and screen input detector 33. One or more switches or buttons are illustrated as hardware buttons 44 connected to the system via a hardware button interface 45. The output circuitry of the touch-sensitive display 32 is connected to the system bus 23 via a video driver 37. Other input devices may include a microphone 34 connected through a suitable audio interface 35, or a physical hardware keyboard (not shown). Output devices may include the display 32, or a projector display 36.

In addition to the display 32, the computing device 20 may include other peripheral output devices, such as at least one speaker 38. Other external input or output devices 39, such as a joystick, game pad, satellite dish, scanner or the like may be connected to the processing unit 21 through a USB port 40 and USB port interface 41, to the system bus 23. Alternatively, the other external input and output devices 39 may be connected by other interfaces, such as a parallel port, game port or other port. The computing device 20 may further include or be capable of connecting to a flash card memory (not shown) through an appropriate connection port (not shown). The computing device 20 may further include or be capable of connecting with a network through a network port 42 and network interface 43, and through wireless port 46 and corresponding wireless interface 47 may be provided to facilitate communication with other peripheral devices, including other computers, printers, and so on (not shown). It will be appreciated that the various components and connections shown are examples and other components and means of establishing communication links may be used.

The computing device 20 may be primarily designed to include a user interface. The user interface may include a character, a key-based, or another user data input via the touch sensitive display 32. The user interface may include using a stylus (not shown). Moreover, the user interface is not limited to an actual touch-sensitive panel arranged for directly receiving input, but may alternatively or in addition respond to another input device such as the microphone 34. For example, spoken words may be received at the microphone 34 and recognized. Alternatively, the computing device 20 may be designed to include a user interface having a physical keyboard (not shown).

The device functional elements 50 are typically application specific and related to a function of the electronic device, and are coupled with the system bus 23 through an interface (not shown). The functional elements may typically perform a single well-defined task with little or no user configuration or setup, such as a refrigerator keeping food cold, a cell phone connecting with an appropriate tower and transceiving voice or data information, a camera capturing and saving an image, or communicating with an implantable medical apparatus. In an embodiment, the computing device 20 includes other resource(s) 52.

In certain instances, one or more elements of the thin computing device 20 may be deemed not necessary and omitted. In other instances, one or more other elements may be deemed necessary and added to the thin computing device.

FIG. 2 and the following discussion are intended to provide a brief, general description of an environment in which embodiments may be implemented. FIG. 2 illustrates an example embodiment of a general-purpose computing system in which embodiments may be implemented, shown as a computing system environment 100. Components of the computing system environment 100 may include, but are not limited to, a general purpose computing device 110 having a processor 120, a system memory 130, and a system bus 121 that couples various system components including the system memory to the processor 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, also known as Mezzanine bus.

The computing system environment 100 typically includes a variety of computer-readable media products. Computer-readable media may include any media that can be accessed by the computing device 110 and include both volatile and nonvolatile media, removable and non-removable media. By way of example, and not of limitation, computer-readable media includes non-transitory computer storage media. Computer storage media includes volatile and nonvolatile, removable and non-removable media implemented in any method or technology for storage of information such as computer-readable instructions, data structures, program modules, or other data. Computer storage media includes, but is not limited to, random-access memory (RAM), read-only memory (ROM), electrically erasable programmable read-only memory (EEPROM), flash memory, or other memory technology, CD-ROM, digital versatile disks (DVD), or other optical disk storage, magnetic cassettes, magnetic tape, magnetic disk storage, or other magnetic storage devices, or any other medium which can be used to store the desired information and which can be accessed by the computing device 110. In a further embodiment, a computer storage media may include a group of computer storage media devices. In another embodiment, a computer storage media may include an information store. In another embodiment, an information store may include a quantum memory, a photonic quantum memory, or atomic quantum memory. Combinations of any of the above may also be included within the scope of computer-readable media.

The system memory 130 includes computer storage media in the form of volatile and nonvolatile memory such as ROM 131 and RAM 132. A RAM may include at least one of a DRAM, an EDO DRAM, a SDRAM, a RDRAM, a VRAM, or a DDR DRAM. A basic input/output system (BIOS) 133, containing the basic routines that help to transfer information between elements within the computing device 110, such as during start-up, is typically stored in ROM 131. RAM 132 typically contains data and program modules that are immediately accessible to or presently being operated on by the processor 120. By way of example, and not limitation, FIG. 2 illustrates an operating system 134, application programs 135, other program modules 136, and program data 137. Often, the operating system 134 offers services to applications programs 135 by way of one or more application programming interfaces (APIs) (not shown). Because the operating system 134 incorporates these services, developers of applications programs 135 need not redevelop code to use the services. Examples of APIs provided by operating systems such as Microsoft's “WINDOWS”® are well known in the art.

The computing device 110 may also include other removable/non-removable, volatile/nonvolatile computer storage media products. By way of example only, FIG. 2 illustrates a non-removable non-volatile memory interface (hard disk interface) 140 that reads from and writes for example to non-removable, non-volatile magnetic media. FIG. 2 also illustrates a removable non-volatile memory interface 150 that, for example, is coupled to a magnetic disk drive 151 that reads from and writes to a removable, non-volatile magnetic disk 152, or is coupled to an optical disk drive 155 that reads from and writes to a removable, non-volatile optical disk 156, such as a CD ROM. Other removable/non-removable, volatile/non-volatile computer storage media that can be used in the example operating environment include, but are not limited to, magnetic tape cassettes, memory cards, flash memory cards, DVDs, digital video tape, solid state RAM, and solid state ROM. The hard disk drive 141 is typically connected to the system bus 121 through a non-removable memory interface, such as the interface 140, and magnetic disk drive 151 and optical disk drive 155 are typically connected to the system bus 121 by a removable non-volatile memory interface, such as interface 150.

The drives and their associated computer storage media discussed above and illustrated in FIG. 2 provide storage of computer-readable instructions, data structures, program modules, and other data for the computing device 110. In FIG. 2, for example, hard disk drive 141 is illustrated as storing an operating system 144, application programs 145, other program modules 146, and program data 147. Note that these components can either be the same as or different from the operating system 134, application programs 135, other program modules 136, and program data 137. The operating system 144, application programs 145, other program modules 146, and program data 147 are given different numbers here to illustrate that, at a minimum, they are different copies.

A user may enter commands and information into the computing device 110 through input devices such as a microphone 163, keyboard 162, and pointing device 161, commonly referred to as a mouse, trackball, or touch pad. Other input devices (not shown) may include at least one of a touch-sensitive screen or display surface, joystick, game pad, satellite dish, and scanner. These and other input devices are often connected to the processor 120 through a user input interface 160 that is coupled to the system bus, but may be connected by other interface and bus structures, such as a parallel port, game port, or a universal serial bus (USB).

A display 191, such as a monitor or other type of display device or surface may be connected to the system bus 121 via an interface, such as a video interface 190. A projector display engine 192 that includes a projecting element may be coupled to the system bus. In addition to the display, the computing device 110 may also include other peripheral output devices such as speakers 197 and printer 196, which may be connected through an output peripheral interface 195.

The computing system environment 100 may operate in a networked environment using logical connections to one or more remote computers, such as a remote computer 180. The remote computer 180 may be a personal computer, a server, a router, a network PC, a peer device, or other common network node, and typically includes many or all of the elements described above relative to the computing device 110, although only a memory storage device 181 has been illustrated in FIG. 2. The network logical connections depicted in FIG. 2 include a local area network (LAN) and a wide area network (WAN), and may also include other networks such as a personal area network (PAN) (not shown). Such networking environments are commonplace in offices, enterprise-wide computer networks, intranets, and the Internet.

When used in a networking environment, the computing system environment 100 is connected to the network 171 through a network interface, such as the network interface 170, the modem 172, or the wireless interface 193. The network may include a LAN network environment, or a WAN network environment, such as the Internet. In a networked environment, program modules depicted relative to the computing device 110, or portions thereof, may be stored in a remote memory storage device. By way of example, and not limitation, FIG. 2 illustrates remote application programs 185 as residing on memory storage device 181. It will be appreciated that the network connections shown are examples and other means of establishing a communication link between the computers may be used.

In certain instances, one or more elements of the computing device 110 may be deemed not necessary and omitted. In other instances, one or more other elements may be deemed necessary and added to the computing device such as other resource(s) 125.

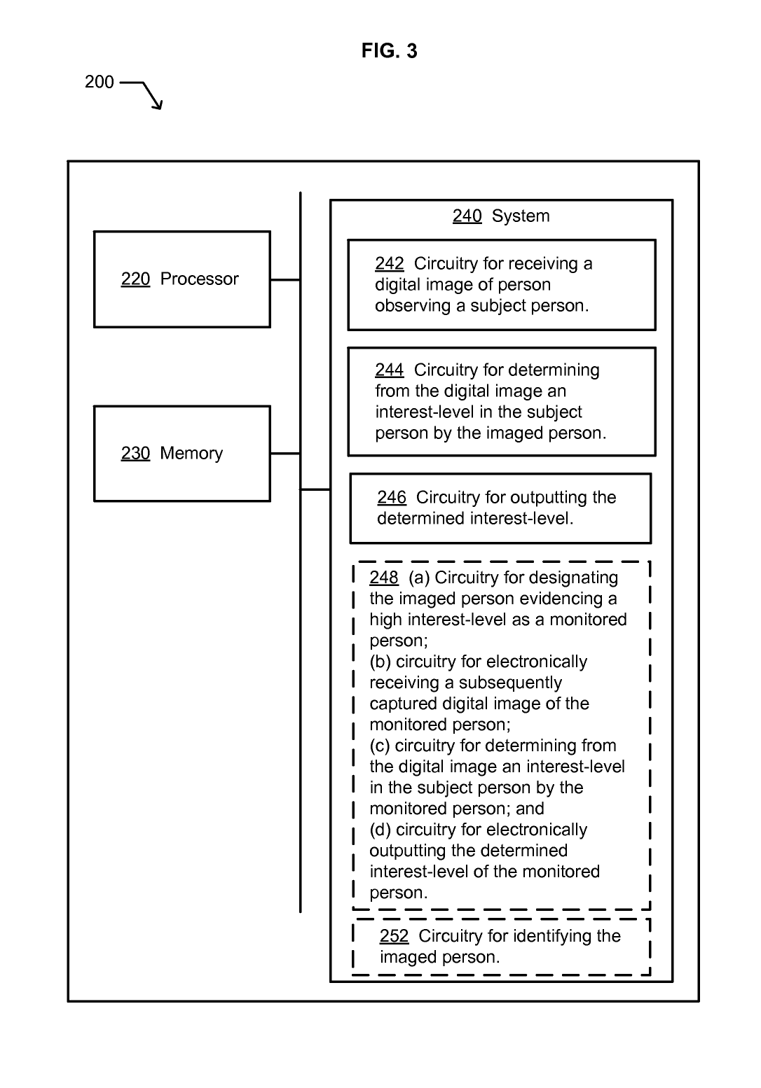

FIG. 3 schematically illustrates an example environment 200 in which embodiments of a system 240 may be implemented. In an embodiment, the environment 200 may be implemented using the thin computing environment 19 that may include a thin computing device 20, which in turn includes the processing unit 21, a system memory 22 as described in conjunction with FIG. 1. In an embodiment, the environment may be implemented using the computing system environment 100 that may include a general purpose computing device 110 having a processor 120, a system memory 130, a system bus 121, and removable or non-removable non-volatile computer storage media products, illustrated by the non-removable hard disk 141 or the removable computer storage media products 152 and 156 as described in conjunction with FIG. 2. In an embodiment, the environment 200 may include circuitry, such as “electrical circuitry” described above. In an embodiment, the environment 200 may include circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of memory (e.g., random access, flash, read only, etc.)), and/or electrical circuitry forming a communications device (e.g., a modem, communications switch, optical-electrical equipment, etc.). Those having skill in the art will recognize that the subject matter described herein may be implemented in an analog or digital fashion or some combination thereof.

The system 240 includes circuitry 242 for receiving a digital image of person observing a subject person. In an embodiment, a subject person includes a human client or a human subject. In an embodiment, a subject person includes a teacher or presenter wanting to know if an audience is paying attention. In an embodiment, a subject person includes seeking a romance or a relationship. The system includes circuitry 244 for determining from the digital image an interest-level in the subject person by the imaged person. The system includes circuitry 246 for outputting the determined interest-level.

In an embodiment of the system 240, the digital image is acquired by a camera configured to automatically capture images of people present within an area where the subject person is present. In an embodiment, the circuitry 244 for determining includes circuitry for determining from the digital image an interest-level rating in the subject person by the imaged person. In an embodiment, the circuitry for determining includes circuitry for determining from the digital image a threat-level rating to the subject person by the imaged person. In an embodiment, the circuitry for determining is responsive to a detected gaze direction of the imaged person, a detected orientation of the imaged person's head or face, or a detected change in gait or posture of the imaged person. In an embodiment, the circuitry 246 for outputting includes circuitry for electronically outputting the determined interest-level in a format compatible with a mobile electronic device. In an embodiment, the circuitry for determining includes circuitry for determining from the digital image an interest-level to the subject person by the imaged person on a scale that includes a high interest-level and a low interest-level. In an embodiment, the circuitry for outputting includes circuitry for outputting an identifier of an imaged person evidencing a high interest-level.

In an embodiment, the system 240 includes the circuitry 248. The circuitry 248 includes circuitry for designating the imaged person evidencing a high interest-level as a monitored person. The circuitry 248 includes circuitry for electronically receiving a subsequently captured digital image of the monitored person. The circuitry 248 includes circuitry for determining from the digital image an interest-level in the subject person by the monitored person. The circuitry 248 includes circuitry for electronically outputting the determined interest-level of the monitored person.

In an embodiment, the system 240 includes circuitry of storing at least one digital image of the monitored person in a non-transitory computer readable storage media. In an embodiment, the system includes circuitry for searching previously acquired digital images of persons observing the subject person for a digital image of the monitored person observing the subject person. In an embodiment, the system 240 includes circuitry for identifying the imaged person. In an embodiment, the circuitry 246 for outputting includes circuitry for outputting the determined interest-level and an identity of the imaged person. In an embodiment, the system 240 includes circuitry for receiving the electronically outputted determined interest-level; and circuitry for broadcasting a notification perceivable by the subject person and responsive to the determined interest-level.

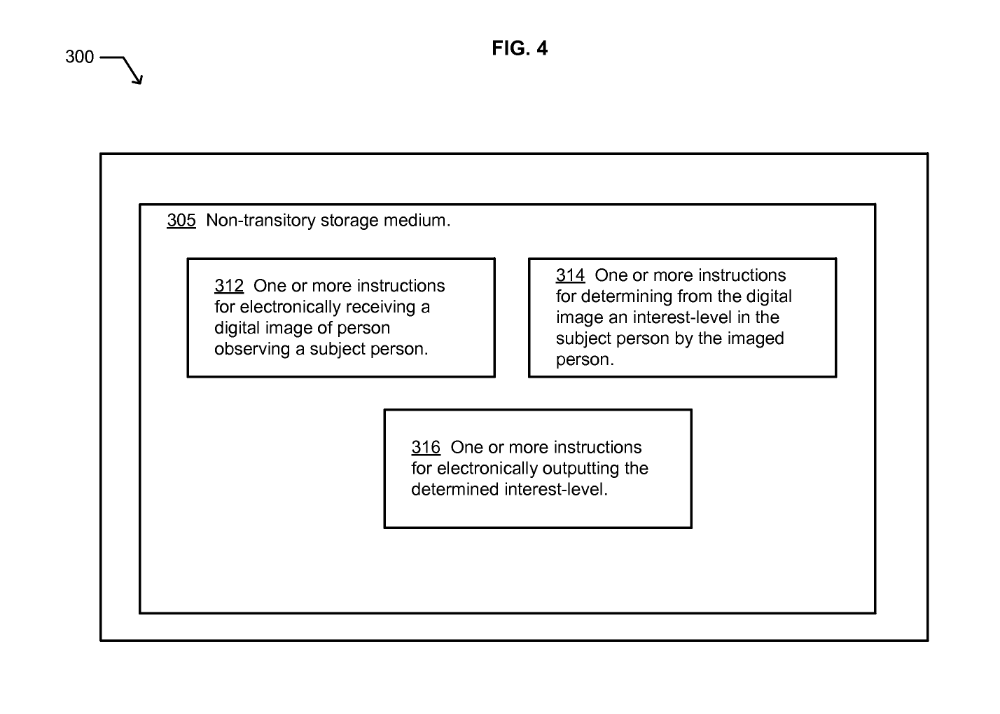

FIG. 4 illustrates an example article of manufacture 300. The article of manufacture includes a non-transitory storage medium 305. The non-transitory storage medium includes one or more instructions 312 for electronically receiving a digital image of person observing a subject person. The non-transitory storage medium includes one or more instructions 314 for determining from the digital image an interest-level in the subject person by the imaged person. The non-transitory storage medium includes one or more instructions 316 for electronically outputting the determined interest-level.

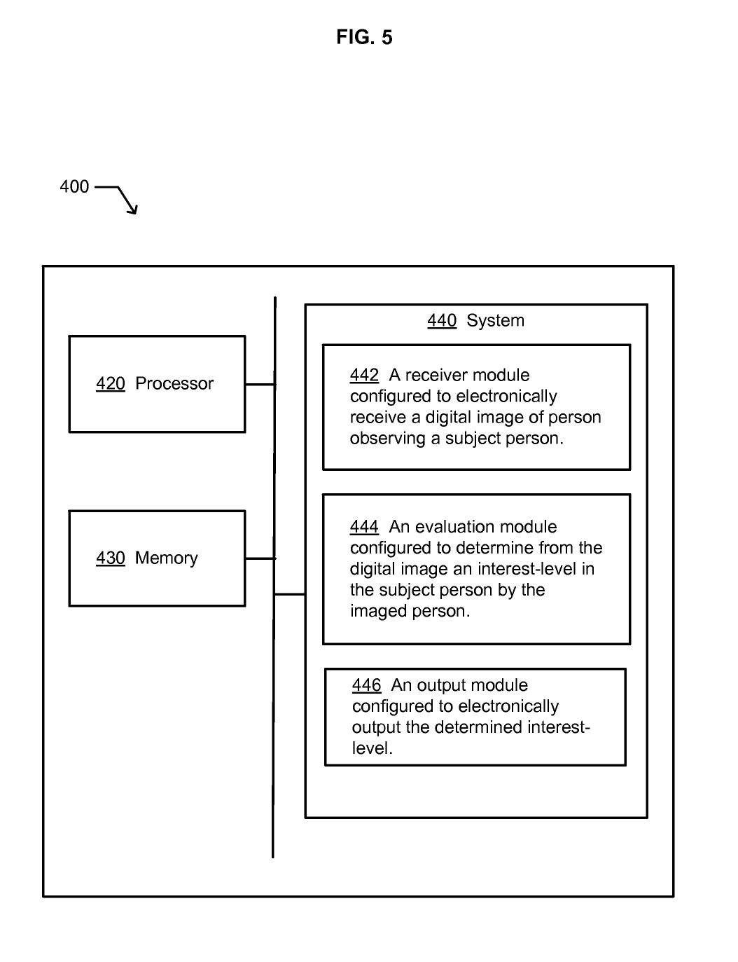

FIG. 5 illustrates an example environment 400 that includes system 440 implemented in a machine, article of manufacture, or composition of matter. The system includes a receiver module 442 configured to electronically receive a digital image of person observing a subject person. The system includes an evaluation module 444 configured to determine from the digital image an interest-level in the subject person by the imaged person. The system includes an output module 446 configured to electronically output the determined interest-level. In an embodiment, the environment may include a processor 420. In an embodiment, the environment may include a memory 430 or other non-transitory storage media.

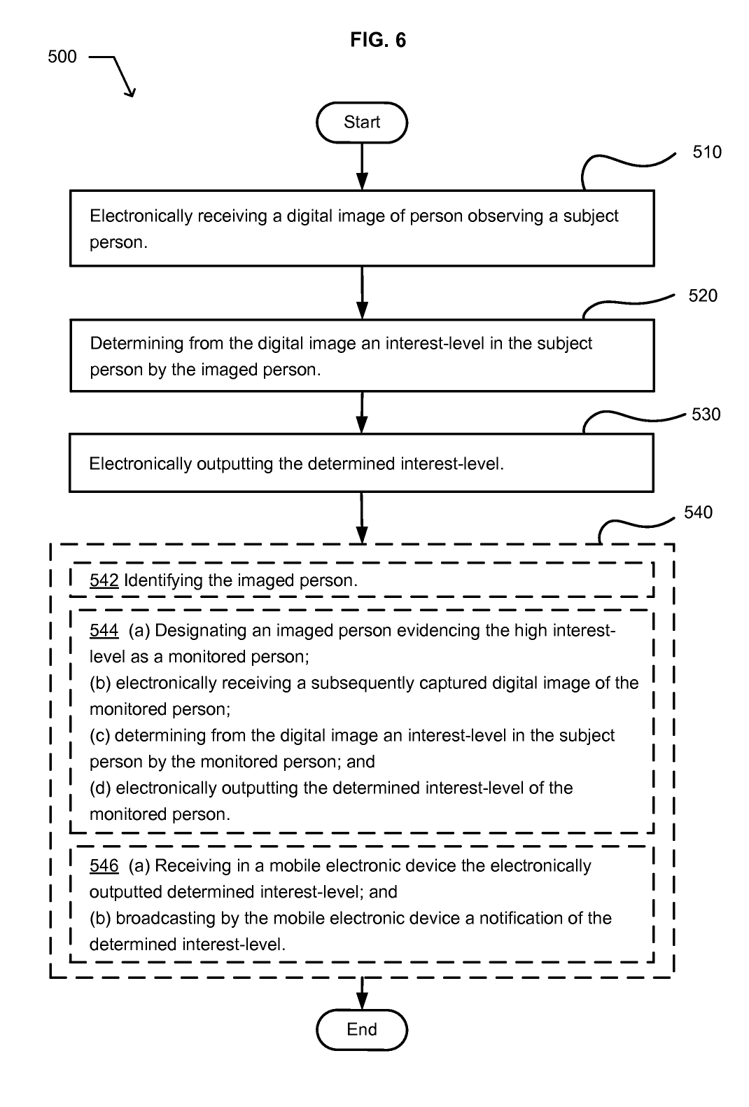

FIG. 6 illustrates an example operational flow of a computer-implemented method 500. After a start operation, an operational flow of the method includes a reception operation 510. The reception operation includes electronically receiving a digital image of person observing a subject person. In an embodiment, the reception operation may be implemented using the circuitry 242 for receiving a digital image of person observing a subject person as described in conjunction with FIG. 3. An evaluation operation 520 includes determining from the digital image an interest-level in the subject person by the imaged person. In an embodiment, the interest-level may be determined in real-time or near real-time, or in non-real time for a future reporting. In an embodiment, the evaluation operation may be implemented using the circuitry 244 for determining from the digital image an interest-level in the subject person by the imaged person as described in conjunction with FIG. 3. A transmitting operation 530 includes electronically outputting the determined interest-level. In an embodiment, the transmitting operation occurs in real-time or in near real-time. In an embodiment, the transmitting operation may be implemented using the circuitry 246 for outputting the determined interest-level as described in conjunction with FIG. 3. The operational flow includes an end operation.

In an embodiment of the reception operation 510, the digital image was acquired by a camera configured to automatically capture images of people present within an area where the subject person is present. For example, the area may include a specified or selected area proximate to the subject person. For example, the area may include an approximate vicinity to the subject person. For example, a room, meeting area, restaurant, convention area, news conference, plaza, stadium, parade, public space, or private space. In an embodiment, the camera is further configured to detect information indicative of an interest-level of the person observing the subject person. In an embodiment, the camera is further configured to detect information indicative of and classify an interest-level of the person observing the subject person. In an embodiment, the camera is carried by the subject person. For example, the subject person may carry multiple cameras facing different directions. In an embodiment, the camera is mounted on a building or other structure. In an embodiment, the person observing include an animal observing the subject person. For example, the animal may include a predator or may include fierce dogs. In an embodiment, the subject person may include a protected animal (e.g., sheep being watched by wolves). For example, the protected animal may include valuable livestock, animals in a zoo, or animals in the wild. In an embodiment, the subject person includes models wearing or carrying products by an advertiser, and the person observing includes a person targeted by the advertiser.

In an embodiment, the evaluation operation 520 includes determining from the digital image an interest-level rating in the subject person by the imaged person. In an embodiment, the evaluation operation includes determining from the digital image an attention-level in the subject person by the imaged person. In an embodiment, the evaluation operation further includes determining from the digital image a threat-level rating evidenced by the imaged person to the subject person. In an embodiment, the evaluation operation further includes determining from the digital image a threat-level classification evidenced by the imaged person to the subject person. In an embodiment, the electronically outputting of the transmitting operation 530 includes electronically outputting the determined interest-level and the threat level classification. In an embodiment, the evaluation operation includes determining responsive to the imaged person's spatial relationship to the subject person. For example, the imaged person's position relative to the subject person may be determined by a camera, by GPS, or by a beacon worn by the subject person. In an embodiment, the evaluation operation includes determining responsive to a detected gaze direction of the imaged person, a detected orientation of the imaged person's head or face, or a detected change in gait or posture of the imaged person. In an embodiment, the determined interest-level is classified responsive to a selected criterion. For example, the criterion may be selected by the subject person or by an entity responsible for the safety of the subject person. In an embodiment, the evaluation operation includes determining responsive to a characteristic of the observation of the subject person by the imaged person. For example, a characteristic may include a length of time during which the imaged person watches the subject person, whether it's a single look or multiple looks, or by whether the imaged person watches the subject person as they move or whether they are stationary. For example, a characteristic may include a pupil size or a change in pupil size. For example, a characteristic may include whether the imaged person is watching the face, body, back, etc. of the subject person. In an embodiment, the determining is responsive to an activity or action by the imaged person. For example, an activity or action by the imaged person may include whether they take a picture of the subject person. For example, an activity or action by the imaged person may include whether they say anything while watching the subject person. For example, an activity or action by the imaged person may include whether they make a threatening gesture, for example with a hand or a weapon. For example, an activity or action by the imaged person may include whether they stop walking to stare. For example, an activity or action by the imaged person may include whether they do something to draw attention, such as stumbling or shouting. In an embodiment, the determining is responsive to an expression by the imaged person. For example, the determining may be responsive to the imaged person changing their activity or expression while watching the subject person, such as smiling or frowning. In an embodiment, the evaluation operation includes determining an interest-level in responsive to a selected class of observing persons of interest. For example, if security is important to the subject person, the selected class may include imaged persons making hostile movements, having unusual clothing or styles, or a wearing clothing or accessories obscuring their facial features or their hands. For example, if romance, dating, or matchmaking is important to the protect person, the selected class may include a sexual orientation or age demographic. In an embodiment, a selected class sieve can be used before determining an interest-level of the person observing. In an embodiment, a selected class sieve can be used to classify two or more persons observing the subject person.

In an embodiment, the transmitting operation 530 includes electronically outputting the determined interest-level in real time. In an embodiment, the interest-level may be electronically outputted in near real time, or in non-real time for a future reporting. In an embodiment, the electronically outputting includes electronically outputting the determined interest-level in a format compatible with a mobile electronic device. In an embodiment, the format includes a format compatible with a mobile electronic device carried by the subject person. In an embodiment, the format includes a format compatible with a mobile electronic device carried by a person accompanying the subject person.

In an embodiment, the operational flow of the method 500 includes at least one additional operation 540. In an embodiment, the at least one additional operation includes a recognition operation 542 identifying the imaged person. For example, the imaged person may be identified using facial recognition. For example, the recognition operation may identify the imaged person as a repeat watcher, whether or not they have been previously individually identified. For example, the recognition operation may be implemented using circuitry for detecting a face of the imaged person; and a circuit for evaluating an interest-level expressed in the face of the imaged person in the subject person. In an embodiment, the transmitting operation 530 includes electronically outputting the determined interest-level and an identity of the imaged person. In an embodiment, the evaluation operation 520 includes determining from the digital image an interest-level in the subject person by the imaged person on a scale that includes a high interest-level and a low interest-level. In an embodiment, the transmitting operation includes electronically outputting an identifier of an imaged person evidencing a high interest-level. In an embodiment, the at least one additional operation includes a designating operation 542 identifying the imaged person.

In an embodiment, the at least one additional operation 540 includes an operation 544. The operation 544 includes designating an imaged person evidencing the high interest-level as a monitored person. The operation includes electronically receiving a subsequently captured digital image of the monitored person. The operation includes determining from the digital image an interest-level in the subject person by the monitored person. The operation includes electronically outputting the determined interest-level of the monitored person. In an embodiment, the designated person to be monitored includes designating the person to be monitored by re-imaging over a period of time. In an embodiment, the designated person to be monitored includes designating the person to be monitored by re-imaging until the person no longer evidences a high interest-level. In an embodiment, the designated person to be monitored includes designating the person to be monitored by re-imaging by at least two digital imaging devices. For example, the re-imaging may include following the imaged person as they move around.

In an embodiment, the at least one additional operation 540 includes storing at least one digital image of the monitored person in a non-transitory computer readable storage media. In an embodiment, metadata, such as time and location of event, or gaze direction of the imaged person may be stored in an association with the at least one digital image. In an embodiment, the at least one additional operation 540 includes searching previously acquired digital images of persons observing the subject person for a digital image of the monitored person observing the subject person. In an embodiment, the transmitting operation 530 includes electronically outputting the determined interest-level of the monitored person based upon current and previously acquired digital images of the monitored person.

In an embodiment, the at least one additional operation 540 includes an operation 546. The operation 546 includes receiving in a mobile electronic device the electronically outputted determined interest-level. The operation includes broadcasting by the mobile electronic device a notification of the determined interest-level. In an embodiment the broadcasting occurs in real time or in near real time. In an embodiment, the broadcasting includes broadcasting using a visual, audio, or haptic component. In an embodiment, the notification is perceivable by the subject person or by a person accompanying the subject person.

In an embodiment, the at least one additional operation 540 includes an additional operation. The additional operation includes broadcasting a notification perceivable by the imaged person and responsive to the determined interest-level. In an embodiment, the notification may include a visual, audio, or haptic component. For example, the notification may be broadcast using a narrow-beam communication model, such as optical, or 60 GHz. For example, the notification may be broadcast using email, cell phone, or internet.

In an embodiment of the operational flow of the method 500, at least one of the reception operation 510 or the evaluation operation 520 is performed by a mobile electronic device carried by or physically associated with the subject person or by a person accompanying the subject person. In an embodiment, at least one of the reception operation 510, the evaluation operation 520, or transmitting operation 530 is performed by a remotely located electronic device.

All references cited herein are hereby incorporated by reference in their entirety or to the extent their subject matter is not otherwise inconsistent herewith.

In some embodiments, “configured” includes at least one of designed, set up, shaped, implemented, constructed, or adapted for at least one of a particular purpose, application, or function.

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to claims containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations. In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that typically a disjunctive word and/or phrase presenting two or more alternative terms, whether in the description, claims, or drawings, should be understood to contemplate the possibilities of including one of the terms, either of the terms, or both terms unless context dictates otherwise. For example, the phrase “A or B” will be typically understood to include the possibilities of “A” or “B” or “A and B.”

The herein described aspects depict different components contained within, or connected with, different other components. It is to be understood that such depicted architectures are merely examples, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality. Any two components capable of being so associated can also be viewed as being “operably couplable” to each other to achieve the desired functionality. Specific examples of operably couplable include but are not limited to physically mateable or physically interacting components or wirelessly interactable or wirelessly interacting components.

With respect to the appended claims the recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Use of “Start,” “End,” “Stop,” or the like blocks in the block diagrams is not intended to indicate a limitation on the beginning or end of any operations or functions in the diagram. Such flowcharts or diagrams may be incorporated into other flowcharts or diagrams where additional functions are performed before or after the functions shown in the diagrams of this application. Furthermore, terms like “responsive to,” “related to,” or other past-tense adjectives are generally not intended to exclude such variants, unless context dictates otherwise.

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

What is claimed is:

1. A system comprising:
circuitry for receiving a digital image of person observing a subject person;
circuitry for determining from the digital image an interest-level in the subject person by the imaged person; and
circuitry for outputting the determined interest-level.

2. The system of claim 1, wherein the digital image is acquired by a camera configured to automatically capture images of people present within an area where the subject person is present.

3. The system of claim 1, wherein the circuitry for determining includes circuitry for determining from the digital image an interest-level rating in the subject person by the imaged person.

4. The system of claim 1, wherein the circuitry for determining includes circuitry for determining from the digital image a threat-level rating to the subject person by the imaged person.

5.-7. (canceled)

8. The system of claim 1, wherein the circuitry for determining includes circuitry for determining from the digital image an interest-level to the subject person by the imaged person on a scale that includes a high interest-level and a low interest-level.

9. (canceled)

10. The system of claim 8, further comprising:
circuitry for designating the imaged person evidencing a high interest-level as a monitored person.

11. The system of claim 10, further comprising:
circuitry for electronically receiving a subsequently captured digital image of the monitored person;
circuitry for determining from the digital image an interest-level in the subject person by the monitored person; and
circuitry for electronically outputting the determined interest-level of the monitored person.

12.-13. (canceled)

14. The system of claim 1, further comprising:
circuitry for identifying the imaged person.

15. The system of claim 14, wherein the circuitry for outputting includes circuitry for outputting the determined interest-level and an identity of the imaged person.

16.-17. (canceled)

18. A system implemented in a machine, article of manufacture, or composition of matter comprising:
a receiver module configured to electronically receive a digital image of person observing a subject person;
an evaluation module configured to determine from the digital image an interest-level in the subject person by the imaged person; and
an output module configured to electronically output the determined interest-level.

19. A computer-implemented method comprising:
electronically receiving a digital image of person observing a subject person;
determining from the digital image an interest-level in the subject person by the imaged person; and
electronically outputting the determined interest-level.

20. The method of claim 19, wherein the digital image was acquired by a camera configured to automatically capture images of people present within an area where the subject person is present.

21. (canceled)

22. The method of claim 20, wherein the camera is carried by the subject person.

23. The method of claim 20, wherein the camera is mounted on a building or other structure.

24. The method of claim 20, wherein the camera includes at least two cameras configured to automatically capture images of people present within an area where the subject person is present.

25.-28. (canceled)

29. The method of claim 19, wherein the determining includes determining from the digital image an interest-level rating in the subject person by the imaged person.

30. The method of claim 19, wherein the determining includes determining from the digital image an attention-level in the subject person by the imaged person.

31. The method of claim 19, wherein the determining includes determining from the digital image a threat-level rating evidenced by the imaged person to the subject person.

32. The method of claim 19, wherein the determining includes determining from the digital image a threat-level classification evidenced by the imaged person to the subject person.

33. The method of claim 19, wherein the determining includes determining an interest-level in the subject person by the imaged person in response to a tracked change in eye movement, gaze direction, head position, body position, or gait of the imaged person.

34. The method of claim 32, wherein the electronically outputting includes electronically outputting the determined interest-level and the threat level classification.

35. The method of claim 19, wherein the determining is responsive to the imaged person's spatial relationship to the subject person.

36.-40. (canceled)

41. The method of claim 19, wherein the determining includes determining an interest-level in responsive to a selected class of observing persons of interest.

42. The method of claim 19, wherein the electronically outputting includes electronically outputting the determined interest-level in real time.

43.-45. (canceled)

46. The method of claim 19, further comprising:
identifying the imaged person.

47. The method of claim 46, wherein the electronically outputting includes electronically outputting the determined interest-level and an identity of the imaged person.

48. The method of claim 19, wherein the determining includes determining from the digital image an interest-level in the subject person by the imaged person on a scale that includes a high interest-level and a low interest-level.

49. The method of claim 48, wherein the electronically outputting includes electronically outputting an identifier of an imaged person evidencing a high interest-level.

50. The method of claim 48, further comprising:
designating an imaged person evidencing the high interest-level as a monitored person;
electronically receiving a subsequently captured digital image of the monitored person;
determining from the digital image an interest-level in the subject person by the monitored person; and
electronically outputting the determined interest-level of the monitored person.

51. (canceled)

52. The method of claim 50, wherein the designated person to be monitored includes designating the person to be monitored by re-imaging over a period of time.

53. The method of claim 50, wherein the designated person to be monitored includes designating the person to be monitored by re-imaging until the person no longer evidences a high interest-level.

54. (canceled)

55. The method of claim 50, further comprising:
storing at least one digital image of the monitored person in a non-transitory computer storage media.

56. The method of claim 50, further comprising:
searching previously acquired digital images of persons observing the subject person for a digital image of the monitored person observing the subject person.

57. The method of claim 56, wherein the electronically outputting includes electronically outputting the determined interest-level of the monitored person based upon current and previously acquired digital images of the monitored person.

58. The method of claim 19, further comprising:
receiving in a mobile electronic device the electronically outputted determined interest-level; and
broadcasting by the mobile electronic device a notification of the determined interest-level.

59. The method of claim 58, wherein the notification includes a human perceivable notification.

60.-61. (canceled)

62. The method of claim 19, further comprising:
receiving in an electronic device the electronically outputted determined interest-level; and
broadcasting a notification perceivable by the imaged person and responsive to the determined interest-level.

63.-64. (canceled)
